(19) United States
(12) Patent Application Publication
(10) Pub. No.: US 2007/0086437 A1
(43) Pub. Date: Apr. 19, 2007

(54) Method and apparatus for controlling reception of multimedia broadcast/multicast services at a mobile station

(75) Inventors: Robert A. DiFazio, Greenlawn, NY (US); Narayan Parappil Menon, Syosset, NY (US); Peter Shaomin Wang, E. Setauket, NY (US); Stephen E. Terry, Northport, NY (US); Renuka Racha, Kings Park, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/284,166

(22) Filed: Nov. 21, 2005

Related U.S. Application Data
(60) Provisional application No. 60/726,627, filed on Oct. 14, 2005.

(51) Int. Cl. H04L 12/66

(52) U.S. Cl. 370/352

(57) ABSTRACT

A method and apparatus for controlling reception of multimedia broadcast/multicast services (MBMS) at a wireless transmit/receive unit (WTRU) are disclosed. In order to control reception of an unwanted service of the MBMS, the WTRU is enabled or disabled for receiving MBMS in accordance with a user input. The unwanted service may be blocked at an application layer or at a lower layer. Either all services or a selected individual service may be blocked. The selection may be based on a type or priority of the content. The selection may be overridden for providing a certain service. To block the unwanted service, reception of an MBMS announcement message is disabled. Alternatively, an MBMS identity is prevented from being passed to a lower layer or is passed with a flag indicating that the unwanted service of the MBMS should not be processed.

### CROSS REFERENCE TO RELATED APPLICATION

This application claims the benefit of U.S. Provisional Patent Application No. 60/726,627 filed Oct. 14, 2005, which is incorporated by reference as if fully set forth.

### FIELD OF INVENTION

The present invention is related to wireless communication systems. More particularly, the present invention is related to a method and apparatus for controlling reception of multimedia broadcast/multicast services (MBMS) at a wireless transmit/receive unit (WTRU), (i.e., a mobile station).

### BACKGROUND

MBMS are point-to-multipoint services in which data is transmitted from a single source to multiple recipients. MBMS fall into two categories: multicast services and broadcast services. The multicast services are subscription-based services and the broadcast services are provided to every MBMS-capable WTRU in the service area.

FIG. 1 is a flow diagram of a prior art process 100 for MBMS multicast service reception. For multicast services, a subscription is established between a user and a service provider in advance (step 102). Before multicast service is provided, a service announcement is performed to distribute to subscribers information about the multicast service, parameters required for service activation and other related parameters such as a service start time (step 104). The subscribers then join a multicast group (step 106). By joining, each subscriber indicates to the network that the subscriber wants to receive multicast services. A session is started when the multicast service is ready to be provided (step 108). MBMS notification is then performed to inform the WTRU about forthcoming MBMS multicast data transfer (step 110). MBMS data is then transferred to the WTRU (step 112). A session is stopped when there is no more data to be sent for some period of time (step 114). The subscriber may leave a multicast group when the subscriber stops receiving multicast services (step 116).

FIG. 2 is a flow diagram of a prior art process 200 for broadcast service reception. The process 200 is similar to process 100 except there are no steps for subscription, joining and leaving since the service is provided to every MBMS-capable WTRU in the service area. The steps 202-210 are similar to steps 104 and 108-114, respectively, and will not be repeated for simplicity.

It is anticipated that MBMS would become a prime carrier for commercial advertising media or other content that may not be desired by the user because the content may be annoying, excessive and overwhelming, similar to pop-ups that plague wireline Internet users. This undesired content may be provided via broadcast services or may be a part of a multicast service to which a user has subscribed. Moreover, unwanted broadcasts or multicasts wastefully consume WTRU resources with respect to battery power, processor cycles, memory usage, or the like. However, the prior art does not provide any means to control or disable the reception of unwanted MBMS broadcast services or unwanted parts of a multicast service.

### SUMMARY

The present invention is a method and apparatus for controlling reception of MBMS at a WTRU. In order to control reception of unwanted MBMS, the WTRU is enabled or disabled for receiving MBMS in accordance with a user input. The unwanted MBMS may be blocked at an application layer or at a lower layer. Either all services or a selected individual service may be blocked. The selection may be based on a type of content of the service or a priority of the content. The selection made by the user may be overridden for providing a certain service. To block the unwanted service, reception of an MBMS announcement message is disabled. Alternatively, an MBMS identity is prevented from being passed to a lower layer or is passed with a flag indicating that the unwanted service of MBMS should not be processed.

### BRIEF DESCRIPTION OF THE DRAWINGS

A more detailed understanding of the invention may be had from the following description, given by way of example and to be understood in conjunction with the accompanying drawings wherein:

FIG. 1 is a flow diagram of a prior art process for MBMS multicast service reception;

FIG. 2 is a flow diagram of a prior art process for reception of MBMS;

FIG. 3 shows an exemplary wireless communication system for implementing MBMS in accordance with the present invention;

FIG. 4 is a flow diagram of a process for blocking an unwanted service of MBMS services in accordance with the present invention; and

FIG. 5 is a block diagram of a WTRU for selectively enabling and disabling MBMS in accordance with the present invention.

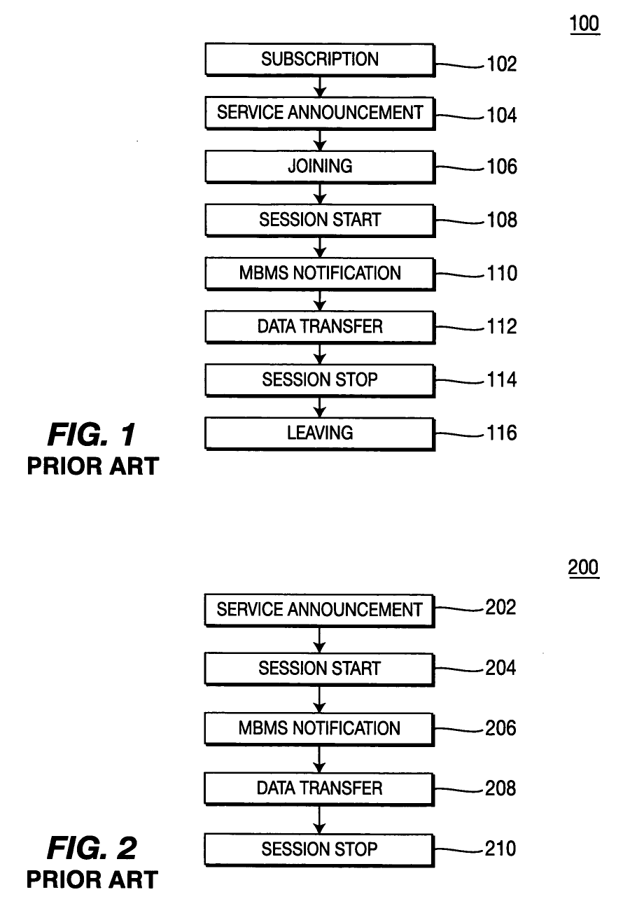

### DETAILED DESCRIPTION OF THE PREFERRED EMBODIMENTS

Hereafter, the terminology “WTRU” includes but is not limited to a user equipment (UE), a mobile station, a fixed or mobile subscriber unit, a pager, or any other type of device capable of operating in a wireless environment.

The features of the present invention may be incorporated into an integrated circuit (IC) or be configured in a circuit comprising a multitude of interconnecting components.

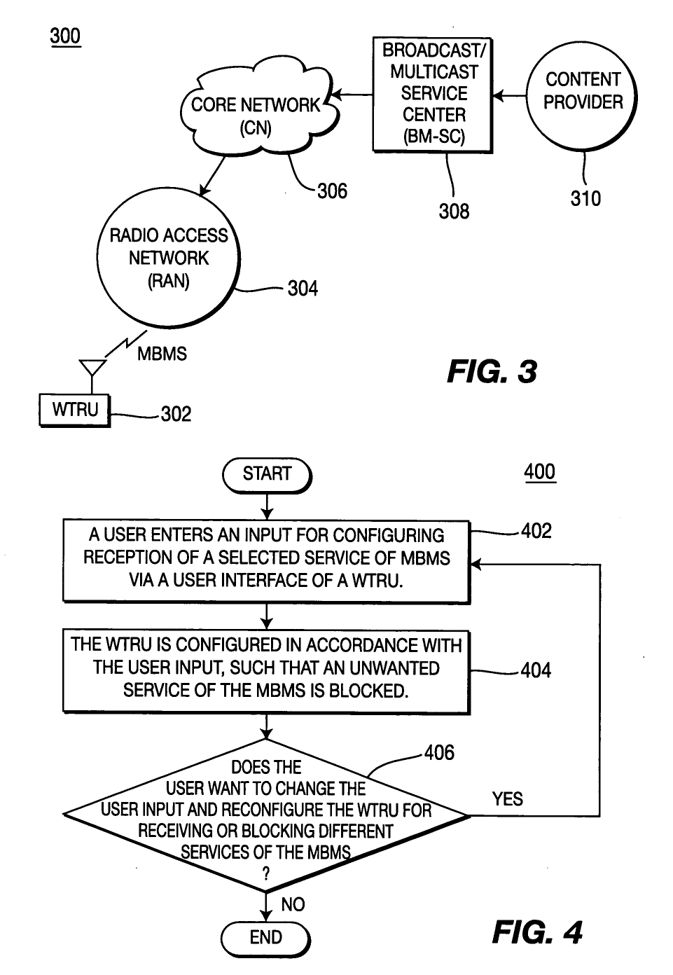

FIG. 3 shows an exemplary wireless communication system 300 for implementing MBMS. The system 300 includes a WTRU 302, a radio access network (RAN) 304, a core network (CN) 306, a broadcast/multicast service center (BM-SC) 308 and a content provider 310. The BM-SC 308 controls MBMS delivery and may serve as an entry point for the content provider 310. MBMS supplied by the content provider 310 are sent to the WTRU 302 via the CN 306 and the RAN 304. The wireless communication system 300 shown in FIG. 3 is provided as an example, and any variance is possible.

FIG. 4 is a flow diagram of a process 400 for blocking an unwanted service of MBMS in accordance with the present invention. A user enters an input for configuring reception of MBMS via a user interface of a WTRU 302 (step 402). The user input enables or disables reception of a service of MBMS. The user input may include an enable/disable setting which is entered before or at any time when MBMS are provided. A default setting may be built into the MBMS application or saved from previous use. The default setting is a set of MBMS parameters that define the selection of various types of MBMS, such as sports casting, traffic condition reporting, local news reception or various advertising broadcasts. The MBMS parameters may be control parameters such as parental control or time control. The default setting may serve as a filter to the service type selection menu on current available services. The enable/disable setting may be applied to all MBMS or may be applied to only some selected services. The selection of services may be performed using an MBMS-ID which will be described hereinafter.

The selection of services may be made based on the type of content of the services. For example, the user may configure the WTRU 302 to receive available software upgrades or service upgrades, but may block advertisements. The information regarding the type of content may be provided by the network or may be based on prior knowledge. Prior knowledge is published MBMS information available to the user, such as service type and its code of access, control schemes, or the like. The selection of services may be made based on a priority of the content, which is signaled by the network. For example, if emergency information is denoted as priority level 1, the selection may be made to receive only priority level 1 MBMS.

Certain content within a broadcast or multicast service may be blocked based on analysis of the content. For example, a filter may be applied to prevent content containing certain objectionable or undesired words or phrases, content containing words or phrases indicating an undesirable source, content of a certain type such as video clips or particular file formats, or content that include large amounts of data that it may be undesirable to store. Furthermore, a filter or algorithm used to analyze and recognize the undesirable content may correlate the content with an MBMS ID. That MBMS ID can be tagged as undesirable and disabled for a certain time duration. The parameters of the filter algorithms, for example the objectionable words, phrases, content source, or file size, may be user-defined settings.

The user setting or service selection may be overridden for certain contents. For example, if a network, equipment manufacturers or law enforcement agencies make a rule that certain MBMS messages must be provided to the user, (e.g., emergency notifications), such contents are provided to the user regardless of the user setting or service selection.

As shown in FIG. 4, the WTRU 302 is then configured in accordance with the input such that an unwanted service of MBMS is blocked (step 404). This configuration may require signaling between protocol layers in the WTRU 302. The unwanted services may be disabled either at an application layer or at a lower layer, such as medium access control (MAC) layer or a physical layer (PHY). Blocking of unwanted services at a lower layer reduces the use of WTRU processing resources. If the user wants to change the user input and reconfigure the WTRU 302 for receiving or blocking different services (step 406), the process 400 then returns to step 402.

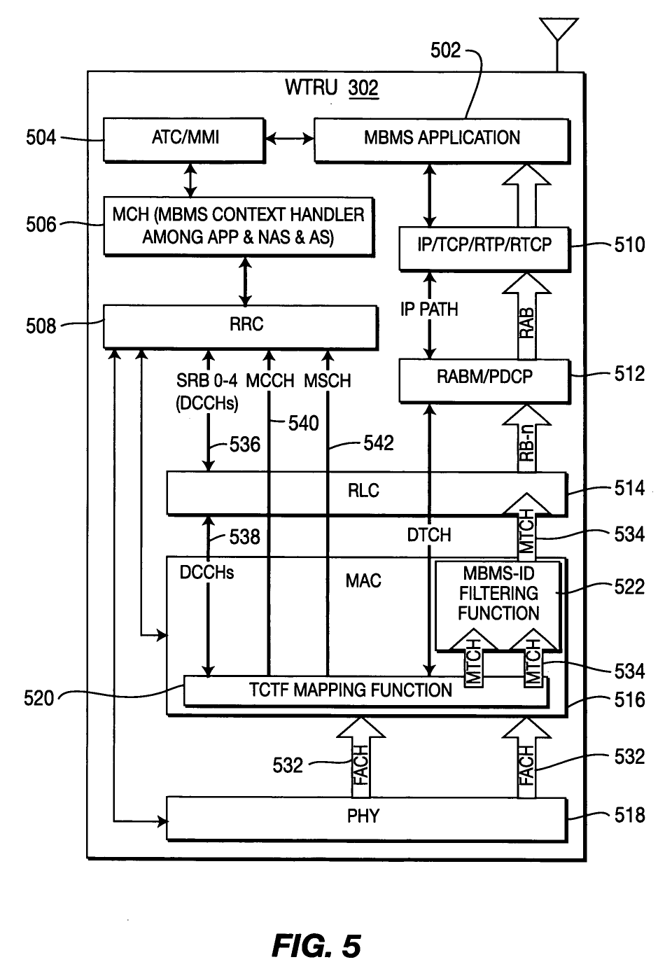

FIG. 5 is a block diagram of a WTRU 302 for selectively enabling and disabling MBMS in accordance with the present invention. The WTRU 302 includes an MBMS application entity 502, an AT command interpreter (ATC)/man machine interface (MMI) 504, an MBMS context handler (MCH) 506, a radio resource control (RRC) entity 508, an Internet protocol (IP) stack 510, a radio access bearer management (RABM)/packet data convergence protocol (PDCP) entity 512, a radio link control (RLC) entity 514, a MAC entity 516 and a PHY entity 518. Hereinafter, the terminology “IP stack” will be used to reference all Internet communication protocols such as Internet protocol (IP), a transport control protocol (TCP), a real-time transmit protocol (RTP) and a real-time transport control protocol (RTCP).

As shown in FIG. 5, the MBMS application entity 502, the IP stack 510 and the ATC/MMI 504 jointly perform the MBMS application control including activation of MBMS, reception of the MBMS announcement, analyzing the MBMS announcement, service selection and joining for the requested multicast service, or the like. The MBMS application entity 502 processes the MBMS announcement broadcast by the network and processes MBMS messages. The ATC/MMI 504 provides an interface to the user and enables data exchange to external devices.

On the user data plane, the IP stack 510, (i.e., IP, TCP, RTP and RTCP), are Internet communication protocol instances employed in the WTRU 302 to support the MBMS application. RABM is a protocol entity in the 3G protocol stack and PDCP is a protocol entity for IP header decompression. The RABM and the PDCP connect the data path between the RLC and the IP stack components.

On the control plane, the signaling radio bearers (SRBs) 536 over dedicated control channels (DCCHs) 538 are used for carrying the basic WTRU operating commands and responses as well as call control or application control commands and responses. The MBMS control channel (MCCH) 540 and the MBMS scheduling channel (MSCH) 542 are MBMS specific control channels such that MBMS information is received via the MCCH 540 and scheduling information about the MBMS traffic channel (MTCH) 534 is received via the MSCH 542. All the control signaling/commands which are sent from the network flow into the RRC entity 508, which configures and controls various components for effective operation of the WTRU 302. The MCH 506 is a specific functional entity designed to coordinate with the RRC entity 508 for the MBMS reception operation of the RABM/PDCP entity 512, the RLC entity 514, the MAC entity 516 and the PHY entity 518 and the high level MBMS subscription and activation activities.

The PHY entity 518 processes received signals through a secondary common control channel (S-CCPCH) and forwards forward access channel (FACH) protocol data units (PDUs) to the MAC entity 516. MBMS are preferably provided through the FACH 532 which is carried via the S-CCPCH. It should be understood to be obvious to those skilled in the art that the services may be provided via any other type of channels and the description of specific channel type in the present invention is provided as an example, not as a limitation, and any variance is possible. The MAC entity 516 includes a target channel type field (TCTF) mapping function 520, which performs TCTF mapping of the received FACH PDUs. The FACH PDU header includes the TCTF which indicates a common logical channel type on the FACH 532. If it is determined from the TCTF that the FACH 532 carries an MTCH 534 for MBMS, the MAC entity 516 forwards the MTCH PDUs to the RLC entity 514 after performing an MBMS-ID filtering.

Still referring to FIG. 5, the MBMS-ID is an identifier of the MTCH 534 for a service of MBMS. The MBMS-ID is included in the MAC header of the MTCH PDU. If the MBMS-ID filtering function 522 of the MAC entity 516 determines that the MBMS-ID of the currently received MTCH PDU matches an MBMS-ID configured for reception, the received MTCH PDU is forwarded to the upper layers for processing, (i.e., the RLC entity 514, the RABM/PDCP entity 512, the IP stack 510 and the MBMS application entity 502). Otherwise, it is blocked from further processing.

In accordance with one embodiment, MBMS may be completely ignored by blocking the reception of the MBMS announcement messages. In order to initiate the MBMS reception, the WTRU 302 should receive and process the MBMS announcement messages. By blocking the reception of the MBMS announcement message, a service of MBMS may be completely ignored. For example, the MBMS application entity 502 may be configured such that it does not issue a command to activate MBMS announcement reception. If operator specific MBMS exist, such as MBMS announcements through short message services (SMS) or audio announcement via voice mail, the MBMS application can be still be configured not to read the programmed network MBMS configuration therefore still blocking any MBMS related reception. With this embodiment, the WTRU 302 cannot receive any MBMS, since the upper layers are not configured to accept MBMS data of any kind.

In accordance with another embodiment, broadcast services are identified from the MBMS announcement message and either passively or actively blocked for reception. When the MBMS signaling link for user service is connected, the IP based MBMS announcement is received by the MBMS application entity 502. From the MBMS announcement, broadcast services are identified and service ID, which is embedded in a temporary mobile group identifier (TMGI), for the broadcast services are collected. For MBMS multicast services, the TMGI is transmitted to the WTRU 302 during the MBMS multicast service activation procedure. For MBMS, the TMGI is obtained via service announcement. The service ID is mapped to a network assigned MBMS-ID at the RRC entity 508 based on the information from MBMS control messages received via the MCCH 540. Multiple service IDs may exist for multiple broadcast services of different kind.

For passive blocking of the broadcast services, the MBMS application entity 502 blocks these broadcast service IDs from being sent to the MCH 506. Therefore, no special MBMS-ID is configured to the MAC entity 516 or PHY entity 518 and the broadcast data stream will not be configured to be received or will be filtered out at the MAC entity 516 or PHY entity 518.

For active blocking of the broadcast services, the MBMS application entity 502 passes the broadcast service IDs to the RRC entity 508 with a flag indicating that it should block the specified FACH 532 at the physical layer if the FACH 532 are only carrying unwanted services of MBMS.

The above passive or active blocking may be applied to either all MBMS or some of the services of MBMS which are deemed as being undesirable. Although the description has used MBMS broadcast services, the same approach can be used to block unwanted MBMS multicast services, even if the user has joined a multicast group.

Alternatively, the MBMS-ID processing and TCTF mapping may be moved from the MAC entity 516 to the PHY entity 518. For some MBMS specific MTCH 534 carrying FACHs 532 that are configured by the RRC entity 508 with a special flag, the tasks of TCTF mapping and MBMS-ID processing and blocking may be implemented in the PHY entity 518 before the MTCH data is passed to the MAC entity 516 via the FACH 532. This scheme has an advantage of avoiding unnecessary processing of unwanted MTCH PDUs at the MAC entity 516.

If a FACH 532 only used for blocked services of MBMS is identified, the processing of the S-CCPCH to which the FACH 532 is mapped at the PHY entity 518 can be further reduced or eliminated.

In the case where soft or selective combining is required, this can also include disabling those unnecessary processing, which can save memory, processing cycles, and power.

Although the features and elements of the present invention are described in the preferred embodiments in particular combinations, each feature or element can be used alone without the other features and elements of the preferred embodiments or in various combinations with or without other features and elements of the present invention.

What is claimed is:

1. In a wireless communication system including a wireless transmit/receive unit (WTRU) and a radio access network (RAN) through which multimedia broadcast/multicast services (MBMS) are provided, a method for controlling reception of the MBMS at the WTRU, the method comprising:
(a) a user entering an input for configuring reception of the MBMS via a user interface of the WTRU; and
(b) configuring the WTRU in accordance with the user input such that an unwanted service of the MBMS is blocked.

2. The method of claim 1 further comprising:
(c) repeating steps (a) and (b) if the user wants to change the user input and reconfigure the WTRU for receiving and blocking different services of the MBMS.

3. The method of claim 1 wherein the unwanted service of the MBMS is blocked by an MBMS application layer.

4. The method of claim 1 wherein the unwanted service of the MBMS is blocked at a lower layer.

5. The method of claim 4 wherein the lower layer is either a medium access control layer or a physical layer.

6. The method of claim 1 wherein all of the MBMS are blocked.

7. The method of claim 1 further comprising determining whether a service of the MBMS is unwanted.

8. The method of claim 7 wherein the determination of the unwanted service is based on a type of content of the service.

9. The method of claim 8 wherein the determination of the unwanted service is based on a priority of the content of the service.

10. The method of claim 7 wherein the unwanted service is overridden.

11. The method of claim 1 wherein the unwanted service of the MBMS is blocked by disabling reception of an MBMS announcement message.

12. The method of claim 1 wherein the unwanted service of the MBMS is blocked by preventing an MBMS identity that is necessary for reception of the unwanted service from being passed to a lower layer.

13. The method of claim 1 wherein the unwanted service of the MBMS is blocked by passing an MBMS identity of the unwanted service to a lower layer with a flag indicating that the unwanted service should not be processed.

14. The method of claim 1 wherein the physical layer processing of a channel carrying the MBMS is reduced or eliminated when the channel does not carry an MBMS announcement message.

15. In a wireless communication system including a wireless transmit/receive unit (WTRU) and a radio access network (RAN) through which multimedia broadcast/multicast services (MBMS) are provided, the WTRU being capable of controlling reception of the MBMS at the WTRU, the WTRU comprising:
a user interface configured to accept an input from a user for configuring reception of the MBMS; and
an MBMS application entity configured to perform MBMS application control in accordance with the user input such that an unwanted service of the MBMS is blocked.

16. The WTRU of claim 15 further comprising an MBMS application layer, wherein the unwanted service of the MBMS is blocked at the MBMS application layer.

17. The WTRU of claim 15 further comprising a lower layer, wherein the unwanted service of the MBMS is blocked at the lower layer.

18. The WTRU of claim 15 wherein the user selects an unwanted service of the MBMS based on a type of content of the service.

19. The WTRU of claim 18 wherein the user selects the unwanted service of the MBMS based on a priority of the content of the service.

20. The WTRU of claim 17 wherein the selection of the unwanted service made by the user is overridden.

21. The WTRU of claim 15 wherein the unwanted service of the MBMS is blocked by disabling reception of an MBMS announcement message.

22. The WTRU of claim 15 wherein the unwanted service of the MBMS is blocked by preventing an MBMS identity that is necessary for reception of the unwanted service from being passed to a lower layer.

23. The WTRU of claim 15 wherein the unwanted service of the MBMS is blocked by passing an MBMS identity of the unwanted service to a lower layer with a flag indicating that the unwanted service should not be processed.

24. The WTRU of claim 15 wherein the physical layer processing of a channel carrying the MBMS is reduced or eliminated when the channel does not carry an MBMS announcement message.

25. In a wireless communication system including a wireless transmit/receive unit (WTRU) and a radio access network (RAN) through which multimedia broadcast/multicast services (MBMS) are provided, an integrated circuit (IC) incorporated in the WTRU which is capable of controlling reception of the MBMS at the WTRU, the IC comprising:
a user interface configured to accept an input from a user for configuring reception of the MBMS; and
an MBMS application entity configured to perform MBMS application control in accordance with the user input such that an unwanted service of the MBMS is blocked.

26. The IC of claim 25 further comprising an MBMS application layer, wherein the unwanted service of the MBMS is blocked at the MBMS application layer.

27. The IC of claim 25 further comprising a lower layer, wherein the unwanted service of the MBMS is blocked at the lower layer.

28. The IC of claim 25 wherein the user selects an unwanted service of the MBMS based on a type of content of the service.

29. The IC of claim 28 wherein the user selects the unwanted service of the MBMS based on a priority of the content of the service.

30. The IC of claim 27 wherein the selection of the unwanted service made by the user is overridden.

31. The IC of claim 25 wherein the unwanted service of the MBMS is blocked by disabling reception of an MBMS announcement message.

32. The IC of claim 25 wherein the unwanted service of the MBMS is blocked by preventing an MBMS identity that is necessary for reception of the unwanted service from being passed to a lower layer.

33. The IC of claim 25 wherein the unwanted service of the MBMS is blocked by passing an MBMS identity of the unwanted service to a lower layer with a flag indicating that the unwanted service should not be processed.

34. The IC of claim 25 wherein the physical layer processing of a channel carrying the MBMS is reduced or eliminated when the channel does not carry an MBMS announcement message.

35. In a wireless communication system including a wireless transmit/receive unit (WTRU) and a radio access network (RAN) through which multimedia broadcast/multicast services (MBMS) are provided, a method for controlling reception of content of the MBMS at the WTRU, the method comprising:
(a) a user entering an input for defining undesired content of the MBMS via a user interface of the WTRU;
(b) monitoring the MBMS for undesired content based on the user input;
(c) detecting undesired content of the MBMS;
(d) correlating the undesired content to an MBMS identifier; and
(e) configuring the WTRU to block content associated with the MBMS identifier until the MBMS identifier is no longer correlated to the undesired content.

36. The method of claim 35 wherein the undesired content includes objectionable or undesired words or phrases.

37. The method of claim 35 wherein the undesired content includes words or phrases indicating an undesirable source.

38. The method of claim 35 wherein the content is undesired if it contains an amount of data that exceeds a predetermined threshold.

39. The method of claim 35 wherein the content is undesired if it contains a certain type of content.

40. The method of claim 39 wherein the certain type of content includes video clips or particular file formats.

41. The method of claim 35 wherein the MBMS identifier is correlated with the undesired content for a predetermined time duration.

42. In a wireless communication system including a wireless transmit/receive unit (WTRU) and a radio access network (RAN) through which multimedia broadcast/multicast services (MBMS) are provided, a method for controlling reception of content of the MBMS at the WTRU, the method comprising:
(a) a user entering an input for defining undesired content of the MBMS via a user interface of the WTRU;
(b) monitoring the MBMS for undesired content based on the user input;
(c) detecting undesired content of the MBMS; and
(d) configuring the WTRU to block the undesired content.

43. The method of claim 42 wherein the undesired content includes objectionable or undesired words or phrases.

44. The method of claim 42 wherein the undesired content includes words or phrases indicating an undesirable source.

45. The method of claim 42 wherein the content is undesired if it contains an amount of data that exceeds a predetermined threshold.

46. The method of claim 42 wherein the content is undesired if it contains a certain type of content.

47. The method of claim 46 wherein the certain type of content includes video clips or particular file formats.
